(19) United States
(12) Patent Application Publication
(10) Pub. No.: US 2016/0157129 A1
(43) Pub. Date: Jun. 2, 2016

(54) COMPRESSING AND TRANSMITTING STRUCTURED INFORMATION

(71) Applicant: Facebook, Inc., Menlo Park, CA (US)

(72) Inventors: Eyal Guthmann, San Francisco, CA (US); Ajit Banerjee, Seattle, WA (US); Shuangtiao Huang, Bellevue, WA (US); Thomas Apostolos Georgiou, Reston, VA (US)

(21) Appl. No.: 14/558,586

(22) Filed: Dec. 2, 2014

(51) Int. Cl. H04W 28/06; H04W 4/00; H04L 29/06

(52) U.S. Cl. CPC H04W 28/065; H04L 69/22; H04W 4/005

(57) ABSTRACT

Various of the present embodiments present a network protocol facilitating intermediary analysis and modification of packets in a compressed data stream is provided. Particularly, a user specified header-payload architecture built using a Machine-to-Machine protocol, e.g., the Message Queueing Telemetry Transport (MQTT™) protocol, may be divided into a “header” and a “payload” portion. The payload may include, e.g., JSON data. Both the “header” and the “payload” portions may be serialized, but only the payload portion may be compressed. An intermediate computing device between the source computing device transmitting the stream and the destination computing device receiving the stream may receive the packet. The intermediate computing device may perform operations using the uncompressed “header”, such as substituting an identifier so as to chronicle the path traveled by the packet to the destination. The intermediate computing device may then retransmit the packet to another intermediate computing device or to the destination computing device.

### BACKGROUND

People increasingly rely upon mobile computing devices to consume data. Unfortunately, the demand for data frequently outpaces the supply of available bandwidth. To use these scarce resources efficiently, bandwidth conscious messaging protocols, such as the Message Queue Telemetry Transport (MQTT™), may be used to reduce protocol overhead. Compression may also be used to reduce the cost imposed on network resources.

Unfortunately, compressed data may be unsuitable for subsequent manipulation, or analysis, particularly at intermediate computing devices, e.g., routers, proxies, or other nodes between the source and destination devices in a network. Users or administrators of such intermediate computing devices may wish, e.g., to analyze, report, or modify data based upon the contents of a compressed message, e.g., a compressed packet. To do so, it may be necessary for the intermediate computing device to decompress each packet in order to perform these operations, which may cause an undesirable increase in consumption of scarce processing resources.

### BRIEF DESCRIPTION OF THE DRAWINGS

The techniques introduced here may be better understood by referring to the following Detailed Description in conjunction with the accompanying drawings, in which like reference numerals indicate identical or functionally similar elements:

FIG. 1 is a block diagram illustrating a packet-traversal topology between various network devices as may occur in some embodiments.

FIG. 2 is a block diagram illustrating components in different packet formats as may occur in some embodiments.

FIG. 3 is a flow diagram depicting aspects of a packet creation and transmission process as may be implemented in some embodiments.

FIG. 4 is a flow diagram depicting receipt and processing of a packet as may occur in some embodiments.

FIG. 5 is a block diagram of a computer system as may be used to implement features of some of the embodiments.

While the flow and sequence diagrams presented herein show an organization designed to make them more comprehensible by a human reader, those skilled in the art will appreciate that actual data structures used to store this information may differ from what is shown, in that they, for example, may be organized in a different manner; may contain more or less information than shown; may be compressed and/or encrypted; etc.

The headings provided herein are for convenience only and do not necessarily affect the scope or meaning of the claimed embodiments. Further, the drawings have not necessarily been drawn to scale. For example, the dimensions of some of the elements in the figures may be expanded or reduced to help improve the understanding of the embodiments. Similarly, some components and/or operations may be separated into different blocks or combined into a single block for the purposes of discussion of some of the embodiments. Moreover, while the various embodiments are amenable to various modifications and alternative forms, specific embodiments have been shown by way of example in the drawings and are described in detail below. The intention, however, is not to limit the particular embodiments described. On the contrary, the embodiments are intended to cover all modifications, equivalents, and alternatives falling within the scope of the disclosed embodiments as defined by the appended claims.

### DETAILED DESCRIPTION

Various embodiments implement a data communications protocol that enables intermediate analysis and/or modification of messages (e.g., packets) that include compressed payloads. A header-payload architecture built using a Machine-to-Machine protocol, e.g., the Message Queueing Telemetry Transport (MQTT™) protocol, may be divided into a “header” portion and a “payload” portion. The payload may include various data that is to be exchanged, e.g., data specified in JavaScript Object Notation (JSON) format. Both the “header” and the “payload” portions may be serialized, e.g., the data structures translated into a format suitable for storage or transmission. However, only the payload portion (or a part of the payload portion) may be compressed. An intermediate computing device (e.g., a router, a proxy, or other node in the network) between a source computing device transmitting the data stream and the destination computing device receiving the data stream may receive messages (e.g., packets) forming the data stream. The intermediate computing device may perform operations using the uncompressed “header” of a message, such as adding, removing, or substituting an identifier so as to chronicle the path traveled by the packet from a source computing device to the destination computing device. The intermediate computing device may then retransmit the packet to another intermediate computing device or to the destination computing device.

Various examples of the disclosed embodiments will now be described in further detail. The following description provides specific details for a thorough understanding and enabling description of these examples. One skilled in the relevant art will understand, however, that the techniques discussed herein may be practiced without many of these details. Likewise, one skilled in the relevant art will also understand that the techniques can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the embodiments. Indeed, certain terms may even be emphasized below; however, any terminology intended to be interpreted in any restricted manner will be overtly and specifically defined as such in this section.

### Overview—Example Network Topology

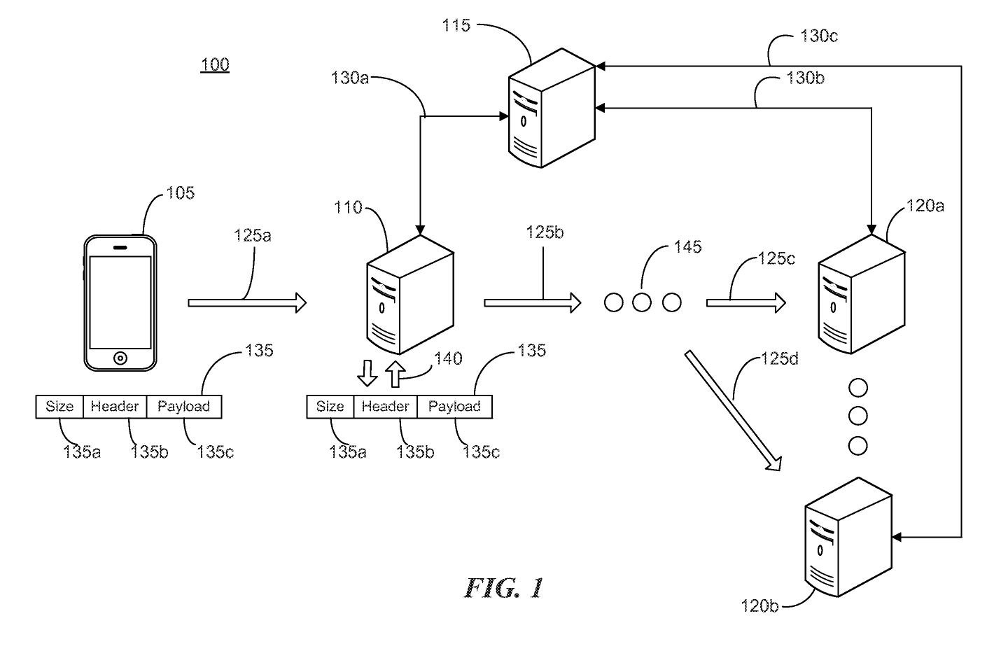

FIG. 1 is a block diagram illustrating a packet-traversal topology between various network computing devices as may occur in some embodiments. A source computing device (“source device”) 105, e.g., a user mobile phone, laptop, desktop, general purpose computing device, etc., may prepare a packet 135 for transport across a network to one or more destination computing devices (“destination devices”), e.g., destination computing devices 120a and/or 120b. The packet may be one in a series transmitted as part of a data stream. Transport across the network may be, e.g., in accordance with the MQTT™ protocol, or another publish-subscribe messaging protocol. In a publish-subscribe messaging protocol the packet 135 may specify the destination computing device(s) at which it is to be received explicitly, or, in some embodiments, the packet 135 may include only a communication class indicating the destination computing devices (e.g., those subscribed to messages associate with the communication class) that are to receive the message.

The packet 135 may include various portions, such as a header size portion 135a, a header portion 135b, and a payload portion 135c. Though depicted separately here for clarity, the header size portion 135a and header portion 135b may both be part of the packet “header”. Consequently, reference to the “header portion” herein may include the size portion 135a when not explicitly distinguished. The header portion 135b may include, e.g., a counter or a log used to record the number and/or character of the intermediate nodes the packet visits en route to the destination computing devices 120a, 120b. In some embodiments, the payload 135c, but not the header 135b, may be compressed, to facilitate analysis of the header 135b at the intermediate computing device 110. In some embodiments, the compression algorithm may compress a stream over an entire session (e.g., from connection to disconnection) between a specific client and server (the server may have the session state as well as the compression state and so may decompress packets as they arrive). When a publish-subscribe messaging pattern is applied, the header may indicate the class of message presented in the packet. One or more of the intermediate computing devices may be a message broker in the publish-subscribe pattern. The header may also provide a unique identifier for recognizing the packet.

Thus, after leaving 125a the source computing device 105, the packet 135 may be received at a first intermediate computing device 110 which may seek to perform various operations 145 upon, or using, the header 135b. For example, the first intermediate computing device 110 may be connected across a network connection 135a with a central system 115 that wishes to monitor the progress of the packet through the network (e.g., to assess efficiency, to modify routing tables, etc.). Such a central system 115 may also be in communication with the plurality of destination computing devices 120a, 120b via connections 130b and 130c.

After, or in parallel, with the modification 140 and/or reporting events occurring at the first node 110, the packet 135 or a copy of the packet 135 may be sent 125b to zero or more intermediate nodes 145 before being received 125c, 125d at each of the one or more destination computing devices 120a, 120c.

As, e.g., in the MQTT™ protocol, packets may be distributed in a “one-to-many” distribution pattern (wherein an intermediate computing device copies the packet and submits each copy to a different destination computing device). Similarly, packets may be delivered in an “at least once”, “at most once”, and/or “exactly once” quality of service level as known in MQTT™. The messaging transport may likewise be agnostic of the content of the payload. For example, the intermediate computing devices may have no knowledge of the structure of the payload and the header may provide no indication of the payload's contents. Thus, only the source and destination computing devices need have knowledge of the compression methods applied herein. Though compression is presented herein for clarify, one will recognize that encryption may be applied in lieu of, or in addition to, compression mutatis mutandis.

### Example Packet Structure

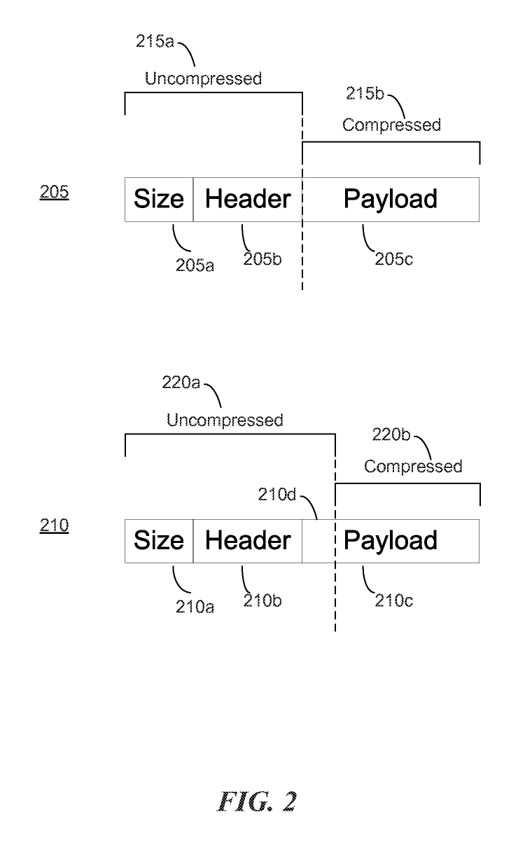

FIG. 2 is a block diagram illustrating components in different packet formats as may occur in some embodiments. A size portion 205a and a header portion 205b may appear separately, or as a single unit, within the packet 205. The size portion 205a may indicate the number of bytes present before a payload 205c (e.g., the bytes containing the header 205b) and may be considered part of the “header” in some embodiments (e.g., the size portion may reflect its own byte length in its value). The size portion 205a may be a fixed size (or one of several pre-established fixed sizes) to facilitate reading of the header by the intermediate computing device 110. In some embodiments, the intermediate computing device 110 may wish to increment a counter within the header 205b or to otherwise read and/or modify the data therein. The header portion 205b may reflect a topic, or category, associated with the packet payload (e.g., dictating how and/or where it is to be delivered). In some embodiments, the format within the header portion 205b may change depending upon the context (e.g., containing one set of fields for one context and a different set of fields for a different context). An envelope protocol, e.g., MQTT™, may dictate the compression of the payload. Various protocols may be used as an envelope protocol to carry messages (e.g., packets) of other protocols, including, e.g., MQTT™. The payload may be flexible, containing, e.g., any variety of JSON objects. The size of the payload may change with successive transmissions. Padding may be used to ensure a consistently sized payload across different packets. This consistent size may facilitate efficient compression. Padding may also be applied to the header to ensure a consistent size (alone or in conjunction with padding of the payload). The size portion may not be necessary where the header is consistently sized via padding. Compression may transcend a single packet, e.g., the compression of data in one packet payload may depend upon data occurring in a subsequent or preceding packet payload. This may be advantageous where the compression ratio improves for longer sequences of data.

The payload 205c may itself compose all or a portion of a communication, e.g., data in a stream such as a Voice Over Internet Protocol (VOIP) stream. These bytes may be compressed 215b to reduce bandwidth (while the header remains uncompressed 215a to facilitate analysis/manipulation at an intermediate computing device). The entire packet contents may serialized. In some embodiments, e.g., in packet 210 the uncompressed 220a and compressed 220b portions need not be strictly limited to the header. For example, the size portion 210a may simply indicate the number of subsequent bytes which are not compressed. These subsequent bytes may include a portion 210d of the payload 210c. Thus, depending upon the context, the protocol may facilitate dynamic management of the compressed and uncompressed portions of the packet. Where necessary, the intermediate computing device may be able to read a portion of the payload, e.g., portion 210d, without decompressing the data (though the intermediate computing device may need to anticipate the serialization of the portion 210d).

In some embodiments, all portions of the packet may be serialized. The extent of the serialization may be indicated in the header 205b, 210b to facilitate interpretation by the intermediate computing devices. Thus, in some embodiments both the header 205b, 210b and payload 205c, 210c may be serialized. The payload 205c, 210c may typically be serialized prior to its compression.

### Example Packet Source Generation Process

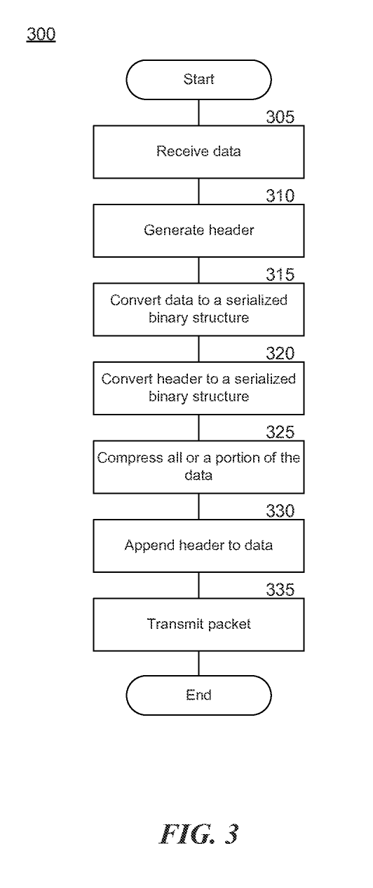

FIG. 3 is a flow diagram depicting aspects of a packet creation and transmission process 300 as may be implemented in some embodiments. For example, the process 300 may be performed, at least in part, at one or more components of source computing device 105. At block 305, a system (e.g., a protocol library running as a process on the source computing device 105) may receive data. For example, an application running on the source computing device 105 may desire to transmit information to one or more destination computing devices 120a,b. The application may provide the data to the protocol library. Based on, e.g., the size of the data, the identities of the destination computing devices, and the context in which the data is sent, the library system may generate an appropriate header at block 310. The header may include metadata as well as an indication of the size of the header preceding the payload.

At block 315, the system may convert the data into a serialized form for insertion into the payload. At block 320, the system may likewise convert the header to a serialized form. The serialized form may be a binary structure representing the data and header respectively. In some embodiments, the packet need not be serialized at blocks 315, 320. The system may decide whether to perform the serialization based upon the application context in some embodiments.

At block 325, the system may compress a portion of the packet, e.g., some or all of the data payload. At block 330, the system may append the header, including, e.g., the size portion indicating the header's uncompressed byte length in serialized form before the payload data (the size portion may simply indicate the number of the byte at which the payload data begins in the serialized packet). At block 335, the system may then transmit the packet to the first intermediate computing device.

### Example Packet Intermediate Handling Process

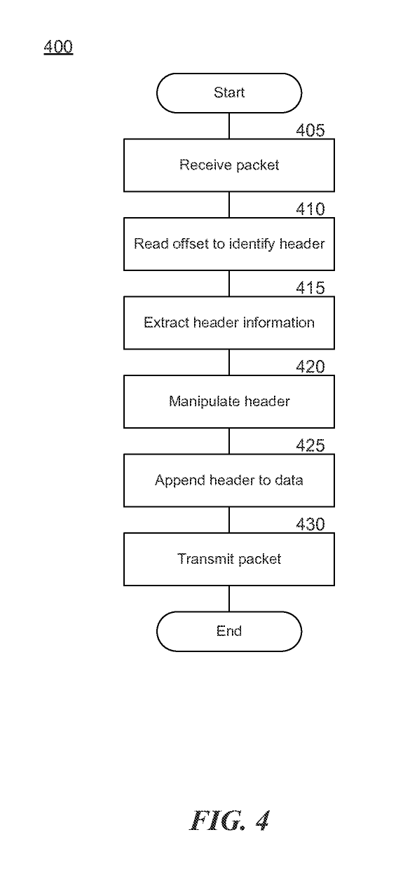

FIG. 4 is a flow diagram depicting a process 400 for receipt and processing of a packet as may occur in some embodiments. At block 405, the system, e.g., intermediate computing device 110, may receive a packet prepared in accordance with FIG. 3. At block 410 the system may read the size offset in, or appended to, the header to determine the header bytes and/or the uncompressed bytes of the packet. Having identified the uncompressed portion, the system may extract and/or modify data from the header at blocks 415 and 425. For example, the system may increment a counter within the header to reflect the number of intermediate nodes the packet encounters en route to the destination. This number may also be relayed to a central system 115. In this manner, the path of the packet may be traced without requiring decompression of the entire packet at each intermediate computing device. Deserialization may not be necessary either, if the desired assessments/operations can be performed using the serialized data. Rather, only the source and destination computing devices may need to have knowledge of the compression methods applied. Similarly, where encryption rather than compression is applied (or encryption in addition to compression) only the source and destination need be able to extract the payload data. The header may also be analyzed to determine how and/or where the packet is to be delivered (e.g., by identifying a class of receiving devices indicated in the header).

As another example, the intermediate computing device may modify the header to reflect the replication of the packet's transmission to other destination computing devices (e.g., modifying the class before the packet reaches a message-broker). The manipulation and use of the header may be context dependent. For example, when the packet relates to audio data one manner of header manipulation may be performed (e.g., reflecting the latency in transmission), whereas when the packet relates to text message data (e.g., reflecting the transmission path) another manner of header manipulation may be performed.

At block 430 the system may transmit the packet to the next intermediate node (e.g., based upon a routing table) or to a destination computing device 120a,b.

### Computer System

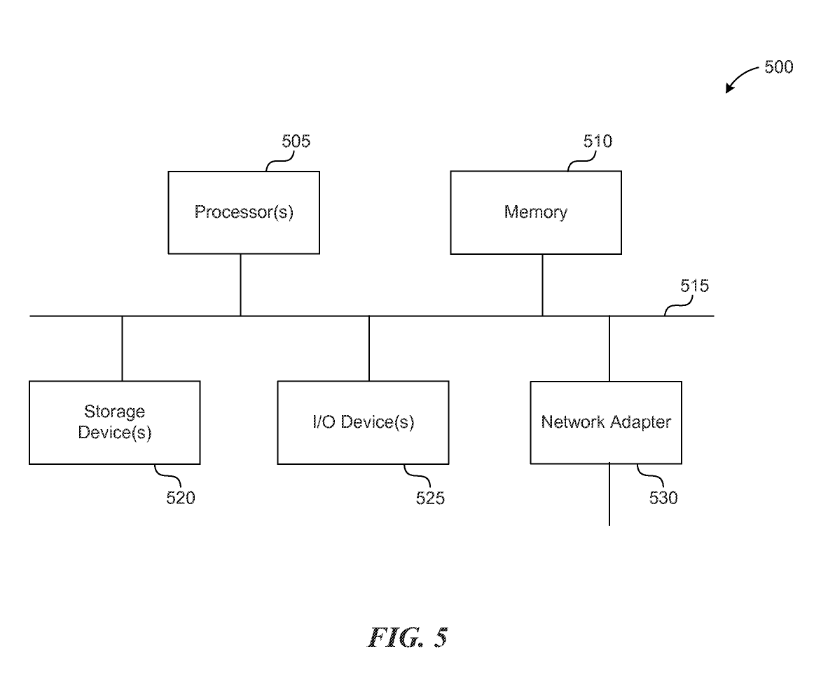

FIG. 5 is a block diagram of a computer system as may be used to implement features of some of the embodiments. The computing system 500 may include one or more central processing units (“processors”) 505, memory 510, input/output devices 525 (e.g., keyboard and pointing devices, display devices), storage devices 520 (e.g., disk drives), and network adapters 530 (e.g., network interfaces) that are connected to an interconnect 515. The interconnect 515 is illustrated as an abstraction that represents any one or more separate physical buses, point to point connections, or both connected by appropriate bridges, adapters, or controllers. The interconnect 515, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”.

The memory 510 and storage devices 520 are computer-readable storage media that may store instructions that implement at least portions of the various embodiments. In addition, the data structures and message structures may be stored or transmitted via a data transmission medium, e.g., a signal on a communications link. Various communications links may be used, e.g., the Internet, a local area network, a wide area network, or a point-to-point dial-up connection. Thus, computer readable media can include computer-readable storage media (e.g., “non transitory” media) and computer-readable transmission media.

The instructions stored in memory 510 can be implemented as software and/or firmware to program the processor(s) 505 to carry out actions described above. In some embodiments, such software or firmware may be initially provided to the processing system 500 by downloading it from a remote system through the computing system 500 (e.g., via network adapter 530).

The various embodiments introduced herein can be implemented by, for example, programmable circuitry (e.g., one or more microprocessors) programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, etc.

### Remarks

The above description and drawings are illustrative and are not to be construed as limiting. Numerous specific details are described to provide a thorough understanding of the disclosure. However, in certain instances, well-known details are not described in order to avoid obscuring the description. Further, various modifications may be made without deviating from the scope of the embodiments. Accordingly, the embodiments are not limited except as by the appended claims.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. One will recognize that “memory” is one form of a “storage” and that the terms may on occasion be used interchangeably.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given above. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

What is claimed is:

1. A computer-implemented method, comprising:
receiving data;
serializing the data;
generating a header based upon the data;
compressing at least a portion of the data; and
generating a packet by appending the header to the data,
wherein the header is not compressed;
wherein the header comprises:
a first field indicating a length of the header;
a second field indicating an attribute of a path taken by the packet; and
a third field indicating a communication class associated with the packet.

2. The computer-implemented method of claim 1, further comprising:
serializing the header.

3. The computer-implemented method of claim 1, wherein the packet complies with a machine-to-machine protocol.

4. The computer-implemented method of claim 1, wherein the third field indicates that the packet is to be delivered to a plurality of destination computing devices.

5. The computer-implemented method of claim 1, wherein the header comprises a field indicating a unique identifier.

6. The computer-implemented method of claim 1, wherein the second field comprises a counter reflecting a number of intermediate computing devices encountered by the packet.

7. The computer-implemented method of claim 1, wherein the data comprises JSON.

8. A computer-implemented method, comprising:
receiving a first packet, the first packet comprising an uncompressed header portion and a compressed payload portion, both the header portion and the payload portion comprising serialized data, wherein the header portion comprises:
a first field indicating a length of the header;
a second field indicating an attribute of a path taken by the packet; and
a third field indicating a communication class associated with the packet;
determining a length of the header portion based upon the first field in the header portion;
determining the content of the second field in the header portion;
providing a value to a networked device based upon the content of the second field; and
transmitting a second packet based upon the first packet.

9. The computer-implemented method of claim 8, the method further comprising:
adjusting a field indicating an attribute of the path taken in the second packet based upon:
the second field in the first packet; and
an identity of the computer.

10. The computer-implemented method of claim 8, wherein the second packet and the first packet are the same packet.

11. The computer-implemented method of claim 8, wherein extracting the value from the serialized data of the header portion.

12. The computer-implemented method of claim 8, wherein the header indicates that the packet is to be delivered to a plurality of destination computing devices.

13. The computer-implemented method of claim 8, wherein the header comprises a counter reflecting a number of intermediate computing devices encountered by the packet.

14. The computer-implemented method of claim 8, wherein the payload comprises JSON.

15. A computer system, comprising:
at least one processor;
at least one memory, the at least one memory comprising instructions configured to cause the at least one processor to perform a method comprising:
receiving data;
serializing the data;
generating a header based upon the data;
compressing at least a portion of the data; and
generating a packet by appending the header to the data,
wherein the header is not compressed;
wherein the header comprises:
a first field indicating a length of the header;
a second field indicating an attribute of a path taken by the packet; and
a third field indicating a communication class associated with the packet.

16. The computer system of claim 15, the method further comprising:
serializing the header.

17. The computer system of claim 15, wherein the packet complies with a machine-to-machine protocol.

18. The computer system of claim 15, wherein the third field indicates that the packet is to be delivered to a plurality of destination computing devices.

19. The computer system of claim 15, wherein the header comprises a field indicating a unique identifier.

20. The computer system of claim 15, wherein the second field comprises a counter reflecting a number of intermediate computing devices encountered by the packet.

21. The computer system of claim 15, wherein the data comprises JSON.
